(19) United States
(12) Patent Application Publication
(10) Pub. No.: US 2010/0166530 A1
(43) Pub. Date: Jul. 1, 2010

(54) STRUCTURAL ARRANGEMENT AT A TRAIN STATION

(76) Inventor: Andrew Philp, Zajnathegyi U.6 (HU)

Correspondence Address: Jay M. Schloff;Intellipex PLLC, Suite 245, 30200 Telegraph Road, Bingham Farms, MI, 48025, US

(21) Appl. No.: 12/344,241

(22) Filed: Dec. 25, 2008

(51) Int. Cl. B65G 67/02

(52) U.S. Cl. 414/343; 414/809

(57) ABSTRACT

Disclosed are a structural arrangement at a train station, and a method for receiving at least one container from a container freight train and disposing an empty container to the container freight train at the train station. The structural arrangement comprises a housing and at least one load maneuvering device. The housing comprises a floor member, a ceiling member, and two pairs of opposite side walls for configuring an interior area. The floor member comprises at least one closeable opening for providing accessibility to the interior area. The housing is disposed over at least one pair of train tracks, such that, the housing is placed directly above the container freight train. The at least one load maneuvering device receives the at least one container from the container freight train into the interior area, and disposes the empty container from the interior area to the container freight train.

### FIELD OF THE INVENTION

The present invention generally relates to structural arrangements at train stations, and, more particularly, to a structural arrangement that is capable of being used for commercial purposes at a train station.

### BACKGROUND OF THE INVENTION

Train stations, typically, serve as loading and unloading halts for passenger trains and freight trains, and, as such, considerable human activity is observed at the train stations. Substantial volume of human traffic and freight pass through the train stations daily, as the passenger trains and the freight trains are preferred mode for safe and economical transport. The volume of human traffic present daily at the train stations has necessitated the need to provide services that cater to passengers. For example, shops, such as coffee shops, refreshment counters, pharmacy shops and, newspaper stalls provide one or more services to the passengers at the train stations. These shops may especially be beneficial for the passengers, who can avail these one or more services while waiting for trains to arrive at their respective train station platforms.

Usually, such shops are established on the train station platforms in railway premises for providing easy and direct accessibility of articles to the passengers waiting for the trains on the train station platforms. The train station platforms are generally designed with an aim of providing enough space to be utilized by the passengers waiting for the trains. Therefore, building such shops occupies a considerable amount of space on the train station platforms, which may hinder various railway operations, and may also be hazardous from a safety point of view.

Furthermore, the train station platforms provide limited space to such shops, as space is required for the passengers to commute, i.e., to board and exit the trains. Space constraints for such shops may prohibit consumption of the articles in a comfortable manner by the passengers. Accordingly, the passengers may not prefer to purchase the articles from such shops for consumption, which may result in reduced business for shop owners.

Moreover, such shops require a continuous supply of the articles from wholesalers located outside the railway premises as and when the articles are in shortage. Delivering the articles, especially large freight containers, to the shops is another major problem. Generally, for delivering the articles to the shops, trolleys are used, which are driven from one shop to another for delivering the articles. The trolleys may occupy further space on the train station platforms, and may pose risk of tripping for the passengers. Further, such deliveries may involve considerable overheads with respect to labor cost and time. Furthermore, in such shops, there may be a problem of storage of delivered articles due to limited size thereof.

Accordingly, there exists a need for efficient utilization of space on train station platforms, especially for commercial purposes. Further, there exists a need for delivering articles, such as large freight containers, in a safe manner and by precluding labor costs. Furthermore, there exists a need for providing a space for storing articles for purchase, and immediate or later consumption or use by passengers at train stations.

### SUMMARY OF THE INVENTION

In view of the foregoing disadvantages inherent in the prior art, the general purpose of the present invention is to provide a structural arrangement at a train station, and, a method for receiving at least one container from a container freight train and disposing an empty container to the container freight train at the train station, which is configured to include all advantages of the prior art, and to overcome the drawbacks inherent therein.

It is accordingly an object of the present invention to provide for efficient utilization of space at train stations, especially for commercial purposes.

Another object of the present invention is to provide a structural arrangement that is built directly above train tracks at train stations for giving an opportunity to train passengers at the train stations to shop in an area set aside as a supermarket in the structural arrangement.

Another object of the present invention is to provide a structural arrangement that is built directly above train tracks at train stations for giving an opportunity to train passengers at the train stations to eat and drink in an area set aside as a café in the structural arrangement.

Another object of the present invention is to provide a structural arrangement that is capable of being supplied with containers having a stock of a plurality of articles solely stored therein, from container freight trains.

Another object of the present invention is to provide a structural arrangement that is capable of offering an environmentally friendly way of supplying a container having a plurality of articles, by container freight trains at train stations, and also capable of offering an environmentally friendly way of shopping the plurality of articles by passengers travelling by passengers trains.

Another object of the present invention is to provide a structural arrangement that is capable of enabling supermarket companies to do profitable business at train stations.

Another object of the present invention is to deliver articles, such as large freight containers, at a train station in a safe manner, and by precluding labor costs.

Another object of the present invention is to provide a space for storing articles for consumption by passengers on train stations.

To achieve the above objects, in an aspect of the present invention, a structural arrangement is provided at a train station. The structural arrangement comprises a housing and at least one load maneuvering device operatively coupled thereto. The housing comprises a floor member, a ceiling member and two pairs of opposite side walls. The two pairs of opposite side walls are disposed between the floor member and the ceiling member to configure an interior area therebetween. Further, the floor member comprises at least one closeable opening for providing accessibility to the interior area. Furthermore, the housing is capable of being disposed over at least one pair of train tracks, such that, the housing is placed directly above a container freight train comprising at least one container. Furthermore, the container freight train comprising the at least one container is capable of moving on a pair of train tracks of the at least one pair of train tracks. Moreover, at least one load maneuvering device is capable of delivering the at least one container from the container freight train to within the interior area through the at least one closeable opening, and disposing an empty container from within the interior area to the container freight train through the at least one closeable opening.

Further in another aspect of the present invention, a method for receiving at least one container from a container freight train and disposing an empty container to the container freight train at a train station is disclosed. The container freight train is capable of moving on a pair of train tracks of at least one pair of train tracks. A structural arrangement is provided over the at least one pair of train tracks. The structural arrangement comprises a housing and at least one load maneuvering device operatively coupled thereto. The housing includes a floor member, a ceiling member and two pairs of opposite side walls. The two pairs of opposite sidewalls are disposed between the floor member and the ceiling member to configure an interior area. Further, the floor member comprises at least one closeable opening for providing accessibility to the interior area. At least one of delivering the at least one container from the container freight train to within the interior area, and disposing the empty container from within the interior area to the container freight train is performed. The delivering and the disposing of the at least one container and the empty container, respectively, are performed by the at least one load maneuvering device on occurrence of alignment of the at least one closeable opening and the at least one container of the container freight train.

The structural arrangement, and more specifically, the housing, disposed over the at least one pair of train tracks, provides efficient utilization of space at train stations, especially for commercial purposes. Further, the at least one load maneuvering device capable of delivering the at least one container from the container freight train to within the interior area, and disposing the empty container from within the interior area to the container freight train enables delivering articles, such as large freight containers, in a safe manner and by precluding labor costs. Furthermore, the interior area configured within the housing provides the space for storing the articles contained in the at least one container for purchase and immediate or later consumption or use by passengers at the train stations.

These together with the other aspects of the present invention, along with the various feature of novelty that characterized the present invention, are pointed out with particularity in the claims annexed hereto and form a part of the present invention. For a better understanding of the present invention, its operating advantages, and the specified object attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawings, wherein like elements are identified with like symbols, and in which:

FIG. 1 illustrates a perspective view of a structural arrangement at a train station, in accordance with an embodiment of the present invention;

FIG. 2 illustrates a perspective view of at least one load maneuvering device for receiving at least one container from a container freight train and disposing an empty container to the container freight train, in accordance with an embodiment of the present invention;

FIG. 3 illustrates a perspective view of a portion of a structural arrangement, wherein at least one closeable opening is in an open position and at least one load maneuvering device receives a container from a container freight train into a housing, in accordance with an embodiment of the present invention;

FIG. 4 illustrates a top view of an interior area of a housing of the structural arrangement of FIG. 1 for depicting an exemplary utilization of a space of the interior area, in accordance with an exemplary embodiment of the present invention; and

FIG. 5 illustrates a flow diagram of a method for receiving at least one container from a container freight train that is capable of moving on a pair of train tracks at a train station and disposing an empty container onto the container freight train at the train station, in accordance with an embodiment of the present invention.

Like reference numerals refer to like parts throughout the description of several views of the drawings.

### DETAILED DESCRIPTION OF THE INVENTION

For a thorough understanding of the present invention, reference is to be made to the following detailed description, including the appended claims, in connection with the above-described drawings. Although the present invention is described in connection with exemplary embodiments, the present invention is not intended to be limited to the specific forms set forth herein. It is understood that various omissions and substitutions of equivalents are contemplated as circumstances may suggest or render expedient, but these are intended to cover the application or implementation without departing from the spirit or scope of the claims of the present invention. Also, it is to be understood that the phraseology and terminology used herein is for the purpose of description and should not be regarded as limiting.

The terms “a” and “an” herein do not denote a limitation of quantity, but rather denote the presence of at least one of the referenced item.

The present invention provides a structural arrangement at a train station, and, a method for receiving at least one container from a container freight train and disposing an empty container to the container freight train at the train station. The structural arrangement, and more specifically, a housing, disposed over at least one pair of train tracks, provides efficient utilization of space on train station platforms, especially for commercial purposes. An interior area configured within the housing provides the space for storing articles contained in the at least one container for purchase and immediate or later consumption or use by passengers at the train station in a convenient and safe manner.

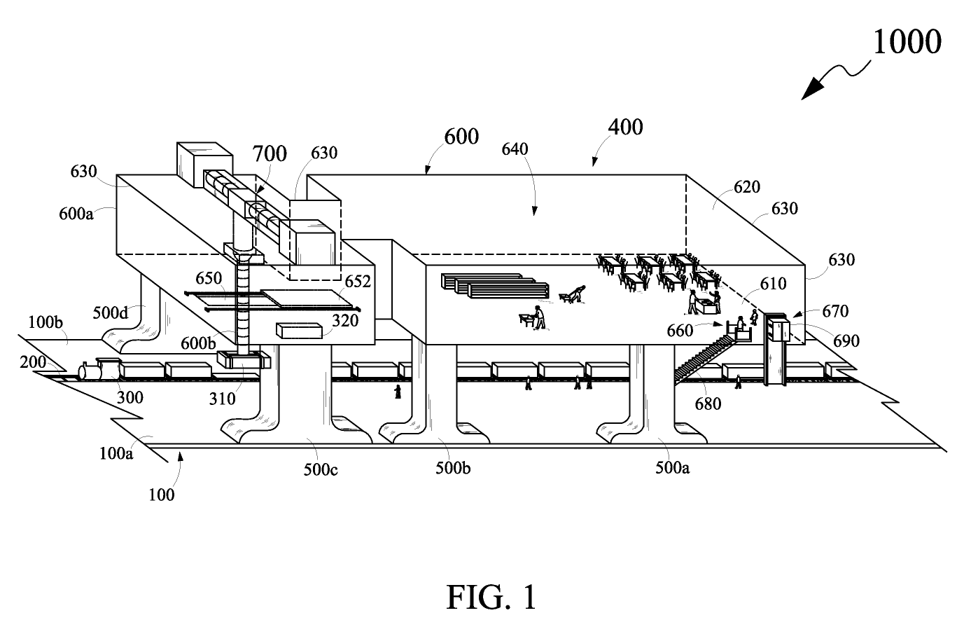

Referring now to FIG. 1, an environment in which various embodiments of the present invention may be practiced is depicted. The environment depicts a perspective view of railway premises 1000. The railway premises 1000 includes a train station, and more particularly, train station platforms, such as a train station platform 100a and a train station platform 100b (hereinafter collectively referred to as ‘platforms 100’). The railway premises 1000 also depicts at least one pair of train tracks, such as a pair of train tracks 200 (hereinafter referred to as ‘train track 200’), a container freight train 300 including at least one container, such as a container 310, and a structural arrangement 400. The train track 200 is disposed in between the platforms 100, and the container freight train 300 is capable of moving on the train track 200.

The structural arrangement 400 includes a housing 600 and at least one load maneuvering device, such as a load maneuvering device 700 (hereinafter referred to as ‘device 700’). The housing 600 includes a floor member 610, a ceiling member 620 and two pairs of opposite sidewalls 630, (hereinafter collectively referred to as ‘sidewalls 630’) disposed between the floor member 610 and the ceiling member 620 for configuring an interior area 640. In one embodiment of the present invention, the floor member 610, the ceiling member 620 and the sidewalls 630 may be pre-assembled at a construction site to configure the housing 600. Such a pre-assembled housing, such as the housing 600 may be transported to the platforms 100 for being established thereon. In another embodiment of the present invention, the floor member 610, the ceiling member 620 and the sidewalls 630 may be assembled together at the platforms 100 to configure the housing 600 established on the platforms 100.

In one embodiment of the present invention, the housing 600 is configured, such that the housing 600 extends along a substantial length of the platforms 100. A length and a breadth of the housing 600 may be configured, such that, the interior area 640 is capable of being used for commercial purposes, such as a supermarket section, and a cafeteria, in addition to being a storage space for containers received from container freight trains, such as the container freight train 300. Further, without limiting the scope of the present invention, in one embodiment, the housing 600 is composed of a steel sheet. However, in another embodiment, the housing 600 may be configured by other metal sheets, plastic sheets, and high density polyethylene plastic sheets.

The floor member 610 includes at least one closeable opening, such as a closeable opening 650, for providing accessibility to the interior area 640. In one embodiment of the present invention, the closeable opening 650 includes a slidable door assembly 652 disposed thereon. The slidable door assembly 652 is capable of slidably opening and slidably closing the closeable opening 650. In addition to the closeable opening 650, the floor member 610 may include one or more entrance openings, such as an entrance opening 660, and an entrance opening 670. The entrance openings 660 and 670 may provide access to the interior area 640 for passengers on the platforms 100. The structural arrangement 400 may further be configured to include at least one elevating means, such as an escalator means 680 and an elevator means 690, capable of elevating the passengers from the platforms 100 to within the housing 600, and lowering the passengers from within the housing 600 to the platform 100. More specifically, the escalator means 680 is capable of elevating and lowering the passengers from the platforms 100 to within the interior area 640 through the entrance opening 660. Similarly, the elevator means 690 is capable of elevating and lowering the passengers from the platforms 100 to within the interior area 640 through the entrance opening 670. It will be evident to those skilled in the art that the elevating means such as the escalator means 680 and the elevator means 690 are depicted for exemplary purposes and that the elevating means may be configured to be a stairway or such other means capable of elevating the passengers from the platforms 100 to within the housing 600, and lowering the passengers from within the housing 600 to the platform 100.

The structural arrangement 400 is established on the platforms 100 by directly placing the housing 600 over the train track 200 on the platforms 100, such that, the container freight train 300 moving on the train track 200 passes from an underside of the housing 600. The direct placement of the housing 600 over the train track 200 is enabled by a plurality of supporting structures, such as a supporting structure 500a, a supporting structure 500b, a supporting structure 500c and a supporting structure 500d. The supporting structures 500a, 500b, 500c and 500d will hereinafter be collectively referred to as ‘supporting structures 500’. Further, such a placement of the housing 600 will be hereinafter referred to as overhead placement of the housing 600.

As depicted in FIG. 1, the supporting structures 500 may be configured to be load-bearing columns. The load-bearing columns may be composed of concrete, steel or any such material capable of suitably supporting a load of the structural arrangement 400. It will evident to those skilled in the art that the housing 600 supported by four supporting structures, such as the supporting structures 500a, 500b, 500c and 500d are depicted for exemplary purposes and that the housing 600 may be supported by any number of supporting structures.

The overhead placement of the housing 600, such that the container freight train 300 passes from the underside of the housing 600, facilitates a direct delivery of containers, such as the container 310, from the container freight train 300 to the interior area 640 of the housing 600. The container 310 that is received within the interior area 640 may include a plurality of articles. The plurality of articles may be any of a whole range of products normally or exceptionally found in supermarkets. Further, additional containers, such as refrigerated containers may also be received within the interior area 640. The plurality of articles included in the container 310 may then be utilized for commercial purposes and an emptied container, may then be disposed directly from the interior area 640 to the container freight train 300. In an embodiment of the present invention, a container, such as the container 310, may be received from the container freight train 300 to within the interior area 640, and, the emptied container, such as an empty container 320, may be disposed from the interior area 640 onto the container freight train 300.

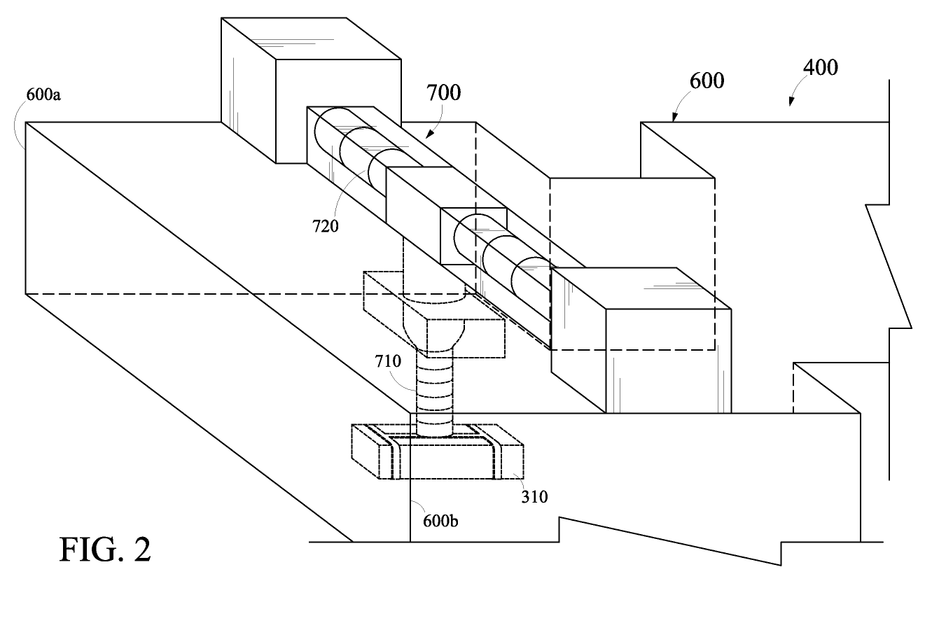

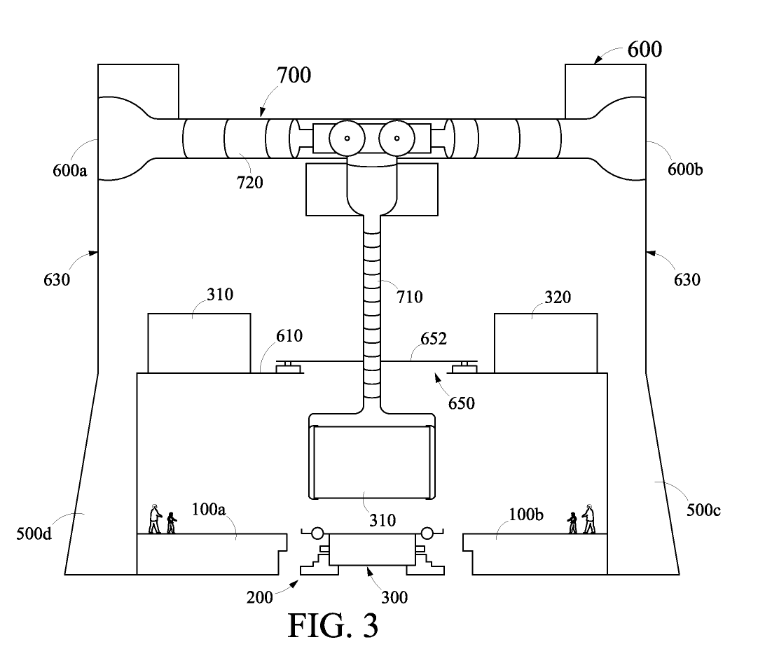

The container 310 may be received from the container freight train 300 into the interior area 640 through the closeable opening 650 using the device 700. Similarly, the empty container 320 may be disposed from the interior area 640 to the container freight train 300 through the closeable opening 650 using the device 700. At least one of delivering the container 310 from the container freight train 300 to within the interior area 640, and disposing the empty container 320 from within the interior area 640 to the container freight train 300 by the device 700 may be performed on occurrence of an alignment of the closeable opening 650 and the container 310 of the container freight train 300. On occurrence of the alignment of the container 310 with the closeable opening 650, the slidable door assembly 652 may be slidably opened for enabling the device 700 to extend downwards through the closeable opening 650 and receive the container 310 from the container freight train 300. On receipt of the container 310, the device 700 may dispose the empty container 320 from the interior area 640 into a slot on the container freight train 300 vacated by the received container 310. It will be evident to those skilled in the art that the closeable opening 650 may be dimensioned to be wide enough for allowing the delivery and disposable of the containers and the empty containers therethrough. In an embodiment of the present invention, the containers, such as the container 310, and the empty container 320 are 40 feet in length. However, it will be evident to a person skilled in the art that various sizes of the containers for carrying the plurality of articles therein, may be delivered and disposed through the closeable opening 650 using the device 700. The device 700 operatively coupled to the housing 600 is explained in detail in conjunction with FIGS. 2 and 3.

Referring now to FIGS. 2 and 3, the device 700 operatively coupled to the housing 600 is depicted. More specifically, FIG. 2 illustrates a perspective view of the device 700 for receiving the container 310, and disposing the empty container 320; and, FIG. 3 illustrates a perspective view of a portion of the structural arrangement 400, wherein the closeable opening 650 is in an open position and the device 700 receives the container 310 from the container freight train 300 into the housing 600, in accordance with an embodiment of the present invention. The device 700, as illustrated in FIGS. 2 and 3 will be described herein with conjunction to FIG. 1. Further, the device 700 as depicted in FIGS. 2 and 3 is for description purpose only, and, not be limited in scope to the configuration as described herein. Moreover, one or more modifications to the device 700 may be contemplated for performing the various functions. As shown in FIGS. 2 and 3, the device 700, according to present embodiment of the invention, is a telescopic hydraulic gantry. Further, it will be evident to those skilled in the art that the device 700 may be any elevating and moving machinery that is capable of receiving and disposing the container 310 and the empty container 320, respectively.

The device 700, as shown in FIGS. 2 and 3 includes a telescopic hydraulic container lifting machinery 710 (hereinafter referred to as ‘container lifting machinery 710’) and a telescopic hydraulic container moving machinery 720 (hereinafter referred to as ‘container moving machinery 720’). The container moving machinery 720 extends from a first end-portion 600a of the housing 600 to an opposite second end portion 600b of the housing 600. The first end-portion 600a and the second end-portion 600b correspond to portions on a pair of opposite side walls of the sidewalls 630 along the length of platforms 100. The container lifting machinery 710 is operatively coupled to the container moving machinery 720, and extends vertically downward therefrom, such that, the container lifting machinery 710 is placed directly above the closeable opening 650, and is capable of extending through the closeable opening 650 for gripping and lifting the container 310 from the container freight train 300 into the housing 600. Once inside the housing 600, the container lifting machinery 710 may be moved laterally by application of hydraulic pressure by the container moving machinery 720 for moving the container lifting machinery 710 within the interior area 640 of the housing 600.

Similarly, the container moving machinery 720 and the container lifting machinery 710 may dispose the empty container 320 from the interior area 640 to the container freight train 300. The container lifting machinery 710 may grip and lift the empty container 320. Further, the container moving machinery 720 may direct the container lifting machinery 710 with the gripped empty container 320 towards the closeable opening 650. On alignment of the gripped empty container 320 with the closeable opening 650, the container lifting machinery 710 may extend vertically in a downward direction for lowering the gripped empty container 320 onto the container freight train 300.

The device 700 is thus configured to ascend, descend, grip, elevate, slide, and release the container 310 and the empty container 320. For the purpose of the description, an operation mode of the device 700 for receiving and disposing the container 310 and the empty container 320, respectively, is explained in conjunction with an exemplary embodiment of the present invention. According to the exemplary embodiment, the slidable door assembly 652 slidably opens the closeable opening 650 on occurrence of the alignment of the closeable opening 650 with the container 310 on the container freight train 300 moving on the train track 200 disposed in between the platforms 100. When the closeable opening 650 is in the open position, the container lifting machinery 710 is laterally moved by the hydraulic pressure applied by the container moving machinery 720 for positioning the container lifting machinery 710 above the closeable opening 650. Further, the container lifting machinery 710 extends to move vertically downward to grip the container 310 from the container freight train 300 by passing through the closeable opening 650.

Thereafter, the container 310 is gripped and moved vertically upwards by hydraulic contraction of the container lifting machinery 710 to move the gripped container 310 within the interior area 640. Furthermore, the container lifting machinery 710 is laterally moved away from the closeable opening 650 for disposing the gripped container 310 on a portion of the floor member 610 by applying the hydraulic pressure by the container moving machinery 720. The gripped container 310 may be disposed by telescopically extending the container lifting machinery 710 to move vertically downwards, and releasing the gripped container 310.

Similarly, disposal of the empty container 320 may be executed by the device 700 from within the interior area 640 of the housing 600 to the container freight train 300. After receiving and disposing of the container 310 and the empty container 320, respectively, the closeable opening 650 may be closed by the slidable door assembly 652.

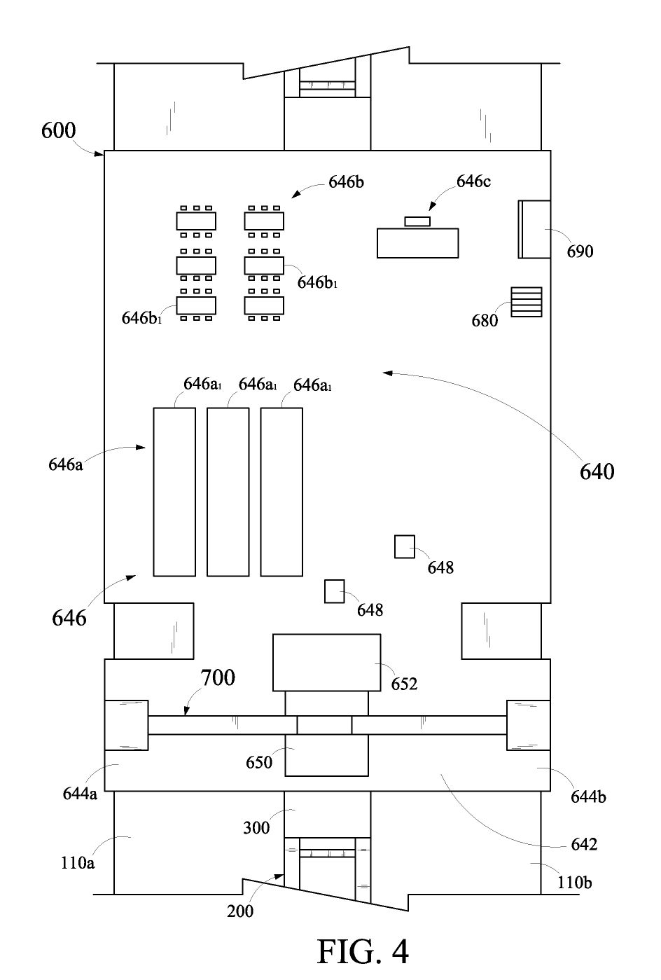

Referring now to FIG. 4, a top view of the interior area 640 of the housing 600 of the structural arrangement 400 for depicting an exemplary utilization of a space of the interior area 640, in accordance with an exemplary embodiment of the present invention. Herein, references will be made to the previous figures to describe the exemplary utilization of the space of the interior area 640. It will be apparent to a person skilled in the art that the exemplary utilization of the space of the interior area 640, as shown in this exemplary embodiment, is for the purpose of illustration only, and may not be considered to be limiting. The interior area 640 may be configured to include a delivery area, a storage area, and a commercial area. In an embodiment of the present invention, for the purposes of representation, a delivery area 642, two storage areas 644a and 644b, and a commercial area 646, are illustrated in FIG. 4. More particularly, the two storage areas 644a and 644b may be categorized into a storage area (hereinafter referred to as ‘container storage area 644a’) for storing the container 310, and a disposal area (hereinafter referred to as ‘container disposal area 644b’) for storing the empty container 320, respectively.

The delivery area 642 is adapted to accommodate the closeable opening 650 and the device 700 therein. Further, the container storage area 644a and the container disposal area 644b (adjacent to the delivery area 642) provide storage area for storing the container 310, and disposal area for disposing the empty container 320, respectively. Further, the commercial area 646 (located adjacent to the delivery area 642) may be utilized for commercial purposes, such as a supermarket, and a café, for performing at least one of purchasing and consuming, and purchasing and taking away the desired articles of the plurality of articles accommodated within the containers, such as the container 310.

More particularly, the delivery area 642 provides a space for operating the closeable opening 650 and the device 700 therein. The closeable opening 650 is configured on the floor member 610 in the delivery area 642. Further, the device 700 is located above the closeable opening 650 in the delivery area 642, and extends therefrom to the container storage area 644a and the container disposal area 644b from the first end portion 600a to the second end portion 600b of the housing 600, respectively. The device 700 is capable of receiving the container 310 from the container freight train 300 through the closeable opening 650 into the delivery area 642 and depositing the container 310 in the container storage area 644a for storing the container 310 therein. Further, the device 700 is capable of disposing the empty container 320 from the container disposal area 644b to the container freight train 300.

The plurality of articles contained in the container 310 may be transported to the commercial area 646 by trolleys 648. The trolleys 648 serve as means for transporting the plurality of articles contained in the containers such as the container 310 to the commercial area 646 from the container storage area 644a. The commercial area 646 may be utilized for various commercial purposes. In one embodiment of the present invention, the commercial area 646 includes the supermarket section, such as a supermarket section 646a, the cafeteria, such as a cafeteria 646b, and a checkout point 646c. It will be apparent to those skilled in the art that utilization of the commercial area 646 as depicted in FIG. 4 is for description purpose only, and, that the commercial area 646 may not be limited in scope to the space utilization as described herein. Moreover, one or more modifications to the commercial area 646 may be contemplated for storing, and optionally consuming the desired articles.

The supermarket section 646a includes a plurality of shelves 646a₁ (as depicted in FIG. 4). In one embodiment of the present invention, the supermarket section 646a includes 10 rows of the plurality of shelves 646a₁, in a manner such that each of two parallel rows of the plurality of shelves 646a₁ defines an aisle therebetween. Each shelf of the plurality of shelves 646a₁ includes the plurality of articles arranged thereon. The passengers may move from one aisle to another aisle for selecting the desired articles from the plurality of shelves 646a₁ to buy the desired articles. Further, the passengers may checkout from the checkout point 646c after paying a bill of the desired articles.

Furthermore, if the passengers are willing to consume the desired articles, he/she may consume the desired articles in the cafeteria 646b provided in the commercial area 646 within the interior area 640. In one embodiment of the present invention, the cafeteria 646b may be provided with a plurality of seating arrangements 646b₁ (as depicted in FIG. 1). In one embodiment of the present invention, the cafeteria 646b may include seating arrangements, such as the plurality of seating arrangements 646b₁, for providing a space to seat at least 100 passengers. The plurality of seating arrangements 646b₁ may be used by the passengers for seating thereon, while consuming the desired articles. Providing the cafeteria 646b, and the supermarket section 646a in the commercial area 646 within the housing 600, enables the housing 600 for being used as a supermarket and café, whereby the passengers may perform the at least one of the purchasing and consuming the desired articles, and may perform the purchasing and taking away the desired articles on their onward journey by passenger trains for later consumption or use, at their homes, places of work or any other place.

Further, on vacating the plurality of articles accommodated in the container 310, the container 310 may be transferred to the container disposal area 644b using the device 700. The container disposal area 644b is capable of storing the empty container 320 therein. Furthermore, the empty container 320 is capable of being disposed by the device 700 from the container disposal area 644b to the container freight train 300 as explained in conjunction with FIGS. 2 and 3.

Further, as explained in conjunction with FIG. 1, the structural arrangement 400 includes the escalator means 680 and the elevator means 690, capable of elevating the passengers from the platforms 100 to within the housing 600, and lowering the passengers from within the housing 600 to the platform 100. More specifically, the escalator means 680 and the elevator means 690 are capable of elevating the passengers from the platforms 100 to within the commercial area 646 for purchasing, and optionally consuming the desired articles therein. Furthermore, the escalator means 680 and the elevator means 690 are capable of lowering the passengers from within the commercial area 646 to the platforms 100.

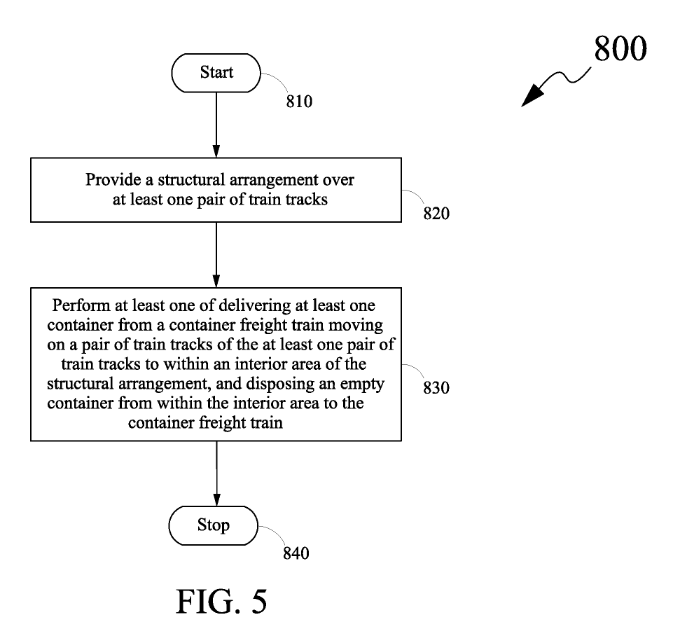

Referring now to FIG. 5, a flow diagram of a method 800 is illustrated, according to an exemplary embodiment of the present invention. Herein, references will be made to the previous figures to describe the method 800. The flow diagram describes the method 800 for receiving the container 310 from the container freight train 300, and disposing the empty container 320 into the container freight train 300.

The method 800 as shown by the flow diagram starts at 810. At 820, the structural arrangement 400 is provided over the train track 200 on the platforms 100. The structural arrangement 400 is supported over the train track 200 by the supporting structures 500, as described in conjunction with FIG. 1. Further, the container freight train 300 that is capable of moving on the train track 200 is positioned at an underside of the structural arrangement 400 by a driver of the container freight train 300. The container freight train 300 carries a at least one container, such as the container 310, that may be received by the structural arrangement 400 upon positioning of the container freight train 300 at the underside of the structural arrangement 400.

Further at 830, at least one of receiving a container, such as the container 310 from the container freight train 300 to within the interior area 640, and disposing an empty container, such as the empty container 320, from within the interior area 640 to the container freight train 300, is performed. The method 800 stops at 840.

For performing the at least one of the receiving of the container 310 and the disposing of the empty container 320, the container freight train 300 is aligned to the closeable opening 650, such that, the container 310 is aligned to the closeable opening 650. More particularly, for receiving the container 310 from the container freight train 300, the device 700 is operated. The container lifting machinery 710 of the device 700 is moved laterally by the hydraulic pressure applied by the container moving machinery 720 for positioning the container lifting machinery 710 above the closeable opening 650. Further, the container lifting machinery 710 extends to move vertically downward to grip the container 310 from the container freight train 300 by passing through the closeable opening 650. Thereafter, the container 310 is gripped and moved vertically upwards by the hydraulic contraction of the container lifting machinery 710 to move the gripped container 310 within the interior area 640. Furthermore, the container lifting machinery 710 is laterally moved away from the closeable opening 650 by exerting the hydraulic pressure by the container moving machinery 720 for disposing the gripped container 310 in the container storage area 644a.

The plurality of articles accommodated in the container 310 may be transported to the commercial area 646 by the trolleys 648 for being purchased, and consumed or taken onward by the passenger trains by the passengers. The passengers may be elevated from the platforms 100 to within the commercial area 646 by the escalator means 680 and the elevator means 690 (as depicted in FIG. 1), for purchasing, and consuming the desired articles. After purchasing and consuming the desired articles, or purchasing and packing the desired articles in bags or backpacks, the passengers may use the escalator means 680 or the elevator means 690 for lowering themselves from within the commercial area 646 to the platforms 100 to continue their train journeys.

Furthermore, for performing the disposal of the empty container 320 from within the container disposal area 644b to the container freight train 300, the container lifting machinery 710 of the device 700 is laterally moved by the hydraulic pressure applied by the container moving machinery 720 for positioning the container lifting machinery 710 in the container disposal area 644b above the empty container 320. Further, the container lifting machinery 710 extends to move vertically downward to grip the empty container 320 from the container disposal area 644b of the housing 600. Thereafter, the container lifting machinery 710 moves vertically upwards due to the hydraulic contraction of the container lifting machinery 710 to move the gripped empty container 320 from the container disposal area 644b. Furthermore, the container lifting machinery 710 is laterally moved by the container moving machinery 720 for locating the container lifting machinery 710 above the closeable opening 650 for disposing the gripped empty container 320 onto the container freight train 300. Accordingly, the container lifting machinery 710 extends vertically downward for disposing the gripped empty container 320 on the container freight train 300.

A structural arrangement, such as the structural arrangement 400 of the present invention, offers following advantages. The structural arrangement utilizes minimum space on train station platforms. Further, the structural arrangement provides an interior area, such as the interior area 640, which may be used as a storage area for storing a container having a plurality of articles accommodated therein, and an empty container. Further, the interior area may also be used as a commercial area by passengers to shop, eat and drink therein conveniently, easily and safely. Furthermore, the structural arrangement enables supermarket owners to do profitable business at the train station platforms. Moreover, a method for receiving and disposing the container and the empty container, respectively, enables the supermarket owners to have goods and products thereof to be delivered uniquely and directly to the structural arrangement by a container freight train. The method is convenient, and is performed without occupying much space at the train station platforms. Also, such method creates a more environment friendly way of receiving and disposing the container and the empty container, respectively. Moreover, the structural arrangement and the method require less involvement of labor, thereby reducing cost of the labor. Furthermore, the structural arrangement of the invention offers general public an opportunity to go supermarket shopping by passenger trains, thereby reducing carbon emissions that may exhausted during use of their private vehicles.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The embodiments were chosen and described in order to best explain the principles of the present invention and its practical application, to thereby enable others skilled in the art to best utilize the present invention and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present invention.

What is claimed is:

1. A structural arrangement at a train station, the structural arrangement comprising:
a housing comprising a floor member, a ceiling member and two pairs of opposite side walls disposed between the floor member and the ceiling member for configuring an interior area, wherein the floor member comprises at least one closeable opening for providing accessibility to the interior area, and, wherein the housing is capable of being disposed over at least one pair of train tracks such that the housing is placed directly above a container freight train comprising at least one container and moving on a pair of train tracks of the at least one pair of train tracks; and
at least one load maneuvering device operatively coupled to the housing, wherein the at least one load maneuvering device is capable of delivering the at least one container from the container freight train to within the interior area through the at least one closeable opening, and disposing an empty container from within the interior area to the container freight train through the at least one closeable opening.

2. The structural arrangement of claim 1, further comprising a plurality of supporting structures for supporting the housing over the at least one pair of train tracks.

3. The structural arrangement of claim 1, further comprising at least one elevating means capable of elevating passengers from a train station platform at the train station to within the housing, and lowering the passengers from within the housing to the train station platform.

4. The structural arrangement of claim 1, wherein the interior area comprises:
a delivery area adapted to accommodate the at least one closeable opening and the at least one load maneuvering device therein, wherein the at least one closeable opening and the at least one load maneuvering device are configured to operate in the delivery area;
a storage area adjacent to the delivery area for storing at least one of the at least one container and the empty container; and
a commercial area adjacent to at least one of the delivery area and the storage area for performing at least one of purchasing and consuming, and purchasing and taking away, a plurality of articles contained in the at least one container.

5. The structural arrangement of claim 1, wherein the at least one closeable opening comprises a slidable door assembly for slidably opening and slidably closing the at least one closeable opening.

6. The structural arrangement of claim 1, wherein the at least one load maneuvering device is a hydraulic gantry.

7. The structural arrangement of claim 1, wherein the housing is made of a steel sheet.

8. A method for receiving at least one container from a container freight train and disposing an empty container to the container freight train at a train station, the container freight train capable of moving on a pair of train tracks of at least one pair of train tracks, the method comprising:
providing a structural arrangement over the at least one pair of train tracks, the structural arrangement comprising a housing and at least one load maneuvering device operatively coupled to the housing, wherein the housing comprises a floor member, a ceiling member and two pairs of opposite side walls disposed between the floor member and the ceiling member for configuring an interior area, and, wherein the floor member comprises at least one closeable opening for providing accessibility to the interior area; and
performing at least one of delivering the at least one container from the container freight train to within the interior area, and disposing the empty container from within the interior area to the container freight train by the at least one load maneuvering device on occurrence of alignment of the at least one closeable opening and the at least one container of the container freight train.

9. The method of claim 8, further comprising supporting the housing by a plurality of supporting structures over the at least one pair of train tracks at the train station.

10. The method of claim 8, wherein the structural arrangement further comprises at least one elevating means capable of elevating passengers from a train station platform at the train station to within the housing, and lowering the passengers from within the housing to the train station platform.

11. The method of claim 8, wherein the interior area comprises:
a delivery area adapted to accommodate the at least one closeable opening and the at least one load maneuvering device therein, wherein the at least one closeable opening and the at least one load maneuvering device are configured to operate in the delivery area;
a storage area adjacent to the delivery area for storing at least the at least one container and the empty container; and
a commercial area adjacent to at least one of the delivery area and the storage area for performing at least one of purchasing and consuming, and purchasing and taking away, a plurality of articles contained in the at least one container.

12. The method of claim 8, wherein the at least one closeable opening comprises a slidable door assembly for slidably opening and slidably closing the at least one closeable opening.

13. The method of claim 8, wherein the at least one load maneuvering device is a hydraulic gantry.

14. The method of claim 8, wherein the housing is made of a steel sheet.
